(19) United States
(12) Patent Application Publication
(10) Pub. No.: US 2008/0189585 A1
(43) Pub. Date: Aug. 7, 2008

(54) SEMICONDUCTOR TESTING SYSTEM

(75) Inventor: Mitsuhisa SATO, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: YOKOGAWA ELECTRIC CORPORATION, Tokyo (JP)

(21) Appl. No.: 12/026,140

(22) Filed: Feb. 5, 2008

(30) Foreign Application Priority Data
Feb. 5, 2007 (JP) 2007-025040

(51) Int. Cl. G06F 11/00

(52) U.S. Cl. 714/738; 714/E11.001

(57) ABSTRACT

There is provided a semiconductor testing system capable of achieving a higher speed in transmission of signals while holding back an increase in the number of transmission paths, and preventing occurrence of a delay time difference between the respective transmission paths. Processing is executed in the semiconductor testing system whereby upon generation of pattern signals by the pattern generator, the pattern signals are subjected to the serial conversion to be transmitted to the test head, while the pattern signals transmitted via the transmission cables subjected to parallel conversion. Another processing is executed whereby the plural kinds of the pattern signals are allocated one by one on an address-by-address basis to be stored in the respective phase control memories to thereby detect the start address storing the pattern signal matching the first pattern signal at the start of the reading, in respect of phase. Then, the test is executed by starting to read from the start address, and sequentially reading the respective pattern signals to be subsequently outputted to the device under test.

### FIELD OF THE INVENTION

The invention relates to a semiconductor testing system for conducting a test by generating pattern signals to be transmitted through transmission paths, respectively, so as to be outputted to a device under test such as a semiconductor memory, a semiconductor IC, and so forth, and in particular, to a circuit configuration for outputting the pattern signals to the device under test after respective phases of the pattern signals are aligned with each other.

### BACKGROUND OF THE INVENTION

In a conventional semiconductor testing system for conducting a test by generating pattern signals including a test pattern for testing a function as well as an operation of a device under test (hereinafter referred to as a DUT) such as a semiconductor memory, a semiconductor IC, and so forth, a system proper thereof, including a pattern generator for generating the pattern signals, and so forth, is made up as a unit separate from a test head connected to the DUT although both are disposed within the same system. When a test is actually conducted, the pattern signals are generated by the system proper to be then transmitted to the test head via respective transmission cables interconnecting the system proper, and the test head, whereupon the test head outputs (applies) the pattern signals to the DUT, thereby conducting the test. With the DUT, there has lately occurred an increase in the degree of higher throughput speed, and to cope with such a trend, an operation for generating the pattern signals requires higher speed.

With a testing system disclosed in Patent Document 1 described hereunder, a device test pattern for testing an electronic device is generated to be subsequently converted into an optical communication signal, and the device test pattern is fed to a test head through optical communications means. A test head causes the device test pattern as converted into the optical communication signal to be re-converted into an electrical signal, whereupon a test on the electronic device is conducted (refer to, for example, Patent Document 1).

### [Patent Document 1] JP 2005-55301 A

With the conventional semiconductor testing system, pattern signals are transmitted from a system proper to a test head in the following manner to thereby conduct a test. FIG. 6 is a schematic representation showing a configuration of the conventional semiconductor testing system 200 for testing a function as well as an operation of a DUT. The semiconductor testing system 200 is made up of a system proper 210 including pattern signal generation means, power supply means, and so forth, a test head 220 for outputting pattern signals to the DUT, and a controller 240 for controlling respective operations of the system proper 210, and the test head 220. The system proper 210 is connected to the test head 220 in such a way as to enable the pattern signals, and data to be transmitted via a plurality of transmission cables 230, respectively.

When a test is actually conducted, a pattern generator 212 of the system proper 210 generates plural kinds of pattern signals in length ranging from several tens to several hundreds of bits as a test signal for a DUT 250 under control by the controller 240. Then, those pattern signals in sync with a clock signal at a cycle of a given time length, generated by a clock generator 211, are transmitted through the intermediary of a plurality of transmission buffers 213 via the transmission cables 230, respectively.

The pattern signals transmitted via the respective transmission cables 230 are received by a plurality of receive-buffers 221 within the test head 220, respectively, and are distributed among respective pin cards 223 connected to the DUT 250 to be outputted, respectively. At the time of testing executed according to a function of each of the pin cards 223, the respective pin cards 223 output the pattern signals outputted from the respective receive-buffers 221 to the DUT 250 in sync with the clock signal similarly transmitted through the intermediary of the respective transmission buffers 213, and the respective receive-buffers 221, thereby conducting a test. With the conventional semiconductor testing system 200, use is made of a method by means of such source-synchronous transfer.

However, the following problem exists with the semiconductor testing system 200 according to the conventional technology. More specifically, if a generation rate of the pattern signal of the pattern generator 212 is increased to cope with a higher throughput speed of the DUT 250, it is necessary to increase the number of the transmission cables in the case where a generation rate of the clock signal generated by the clock generator 211 remains the same as it is. For example, in order to double the generation rate of the pattern signal, the pattern signals twice as many are transmitted in sync with the clock signal at the same timing, so that there arises the need for doubling the number of the transmission cables 230.

Now, the test head 220 need be movable so as to be connected with a handler and so forth for automatic feeding of the DUT 250 by conveying the same, and if there is an increase in the number of the transmission cables 230 in unit ranging from several tens to several hundreds, burden on the transmission cables 230 upon bending or deforming thereof will become excessively large, thereby interfering with movement of the test head 220.

Further, if an attempt is made to increase the generation rate of the pattern signal without increasing the number of the transmission cables 230 in order to secure a movable range of the test head 220, this will then result in the necessity of increasing the generation rate of the clock signal generated by the clock generator 211. In conjunction with that, there is also the need for increasing a transmission speed of each of the transmission cables 230 in proportion to an increase in the generation rate, but this can be implemented by use of an optical fiber.

Meanwhile, the transmission cables 230 have a problem of delay occurring upon signal transmission. More specifically, the respective transmission cables 230 are actually in a range of 5 to 10 m in wiring length, and it is extremely difficult to accurately align respective lengths of the transmission cables 230 ranging in number from several tens to several hundreds of lengths with each other so as to be identical in length. In general, there exists delay time of 5 ns/m (5 ns per 1 m) for every transmission path, and there is the risk of occurrence of a delay time difference ranging from several hundred ps to several ns between the respective transmission cables 230.

FIG. 7 is a schematic representation showing a state of delay time between the respective transmission cables 230 when data blocks from 1 to n are transmitted. For example, if a transfer speed of the transmission cable 230 is 1 Gbps, a transfer cycle of the data block will be 1 ns, and if there occurs a delay time difference, ranging from several hundred ps to several ns between the respective transmission cables 230, the difference accounts for several ten to several hundred % of the transfer cycle of the data. If such delay as described occurs in one cycle of the clock signal, the data n will be lacking in time for Tsetup, whereby the data n as transferred is determined by the respective receive-buffers 221 before occurrence of the next clock signal (the data cannot be determined within the one cycle), as shown in FIG. 7.

### SUMMARY OF THE INVENTION

It is therefore an object of the invention to provide a semiconductor testing system capable of achieving a higher speed in transmission of signals while holding back an increase in the number of transmission paths, and preventing occurrence of a delay time difference between the respective transmission paths.

To that end, the invention provides in its one aspect a semiconductor testing system comprising a pattern generator for generating pattern signals for use in testing a device under test, serial converters for executing serial conversion of the pattern signals generated by the pattern generator, respectively, transmission paths for transmitting the pattern signals subjected to the serial conversion by the serial converters, respectively, a plurality of memories for subjecting the pattern signals transmitted via the respective transmission paths to parallel conversion to be stored therein, and a pattern output unit for starting to read the respective pattern signals from a reading start position of the pattern signal at the time of testing against each of the plurality of the memories to thereby output the respective pattern signals to the device under test.

With the adoption of such a configuration as described, instead of transmitting the pattern signals generated by the pattern generator, in parallel with each other, via the respective transmission paths, the pattern signals are transmitted after the serial conversion, so that it is possible to achieve a higher speed in transmission without increasing the number of cables used in the respective transmission paths. Further, since the pattern signals are outputted to the device under test by starting to read from the reading start position storing, for example, an identical pattern signal out of the plurality of the memories, it is possible to align respective phases of the memories with each other even if there occurs a delay time difference between the respective transmission paths, thereby preventing occurrence of the delay time difference.

Further, the invention provides in its another aspect a semiconductor testing system comprising a pattern generator for generating pattern signals for use in testing a device under test, serial converters for executing serial conversion of the pattern signals generated by the pattern generator, respectively, transmission paths for transmitting the pattern signals subjected to the serial conversion by the serial converters, respectively, parallel converters for executing parallel conversion of the pattern signals transmitted via the respective transmission paths, a plurality of memories for allocating the respective pattern signals subjected to the parallel conversion executed by the parallel converters on the basis of every address to be subsequently stored therein, a start address detection unit for detecting a start address corresponding to a reading start position of the pattern signal at the time of testing from among a plurality of addresses of the memory out of each of the memories, and a pattern output unit for starting to read the respective pattern signals from the start address of each of the plurality of the memories, detected by the start address detection unit, against each of the plurality of the memories, to thereby output the respective pattern signals to the device under test.

With the adoption of such a configuration as described, instead of transmitting the pattern signals generated by the pattern generator, in parallel with each other, via the respective transmission paths, the pattern signals are transmitted after the serial conversion, so that it is possible to achieve a higher speed in transmission without increasing the number of cables used in the respective transmission paths. Further, by reading, for example, identical pattern signals to serve as the first signal at the time of reading, from the start address in each of the plurality of the memories, reading of the pattern signals is started to be thereby outputted to the device under test, so that it is possible to align respective phases of the memories with each other even if there occurs a delay time difference between the respective transmission paths, thereby preventing in effect the delay time difference.

The start address detection unit may comprise a pattern comparator for comparing a first pattern signal at the start of reading at the time of testing, as preset, with the respective pattern signals stored on an address-by-address basis in each of the plurality of the memories, and a pattern comparison detector for detecting an address storing a pattern signal matching the first pattern signal, in respect of phase, on the basis of results of comparison made by the pattern comparator, out of each of the plurality of the memories.

With adoption of such a configuration as described, the first pattern signal at the start of reading at the time of testing, as preset, is compared with the respective pattern signals stored on an address-by-address basis in each of the plurality of the memories, to thereby detect the pattern signal identical to the first pattern signal, in respect of phase, so that the respective pattern signals can be aligned in phase with the first pattern signal even if there occurs a delay time difference between the respective transmission paths.

Further, the pattern comparator may further comprise a pattern setter for optionally setting the first pattern signal to be compared with the respective pattern signals stored on an address-by-address basis in each of the plurality of the memories.

With adoption of such a configuration as described, the first pattern signal at the start of the reading at the time of testing can be optionally changed according to the content and condition of the test to be executed by the semiconductor testing system to be then set, thereby aligning phases of the respective pattern signals with that of the first pattern signal as changed.

Still further, the invention provides in its still another aspect a semiconductor testing system comprising a pattern generator for generating pattern signals for use in testing a device under test, first optical converters for converting the pattern signals generated by the pattern generator, respectively, from electrical signals to optical signals, optical transmission paths for transmitting the optical signals converted by first optical converters, respectively, second optical converters for converting the optical signals transmitted via the optical transmission paths into pattern signals as voltage signals, respectively, a plurality of memories for allocating the respective pattern signals converted by the second optical converters on an address-by address basis to be subsequently stored therein, a start address detection unit for detecting a start address corresponding to a reading start position of the pattern signal at the time of testing from among a plurality of addresses of the memory out of each of the memories, and a pattern output unit for starting to read the respective pattern signals from the start address of each of the plurality of the memories, detected by the start address detection unit, against each of the plurality of the memories, to thereby output the respective pattern signals to the device under test.

With the adoption of such a configuration as described, instead of transmitting the pattern signals generated by the pattern generator, in parallel with each other, via the respective transmission paths, optical signals converted from the pattern signals are transmitted, so that it is possible to achieve a higher speed in transmission without increasing the number of the optical transmission paths by use of an optical fiber, and so forth. Further, by reading, for example, identical pattern signals to serve as the first signal at the time of reading, from the start address in each of the plurality of the memories, reading of the pattern signals is started to be thereby outputted to the device under test, so that it is possible to align respective phases of the memories with each other even if there occurs a delay time difference between the respective transmission paths, thereby preventing occurrence of the delay time difference.

The semiconductor testing system described as above may further comprise an optical multiplexer for transmitting an optical composite signal synthesized of a plurality of optical signals converted by each of the first optical converters via the optical transmission path, and a wavelength demultiplexer for distributing the optical composite signal transmitted via the optical transmission path into a plurality of optical signals.

With the adoption of such a configuration as described, instead of transmitting the optical signals converted from the pattern signals generated by the pattern generator via the respective optical transmission paths, the optical composite signal synthesized of the plurality of optical signals is transmitted, so that it is possible to reduce the number of the optical transmission paths rather than increasing the number thereof by use of an optical fiber, and so forth, thereby achieving a still higher speed in transmission.

With the semiconductor testing system according to the invention, it is possible to obtain advantageous effects of achieving a higher speed in transmission while holding back an increase in the number of the

### BRIEF DESCRIPTION OF THE DRAWINGS

FIG. 1 is a schematic representation showing a configuration of a semiconductor testing system according to a first embodiment of the invention;

FIG. 2 is a schematic representation showing a makeup of phase control memories of the semiconductor testing system according to the first embodiment of the invention;

FIG. 3 is a flow chart showing operation of the semiconductor testing system according to the first embodiment of the invention;

FIG. 4 is a schematic representation showing a configuration of a semiconductor testing system according to a second embodiment of the invention;

FIG. 5 is a schematic representation showing a configuration of a semiconductor testing system according to a third embodiment of the invention;

FIG. 6 is a schematic representation showing a configuration of a conventional semiconductor testing system; and

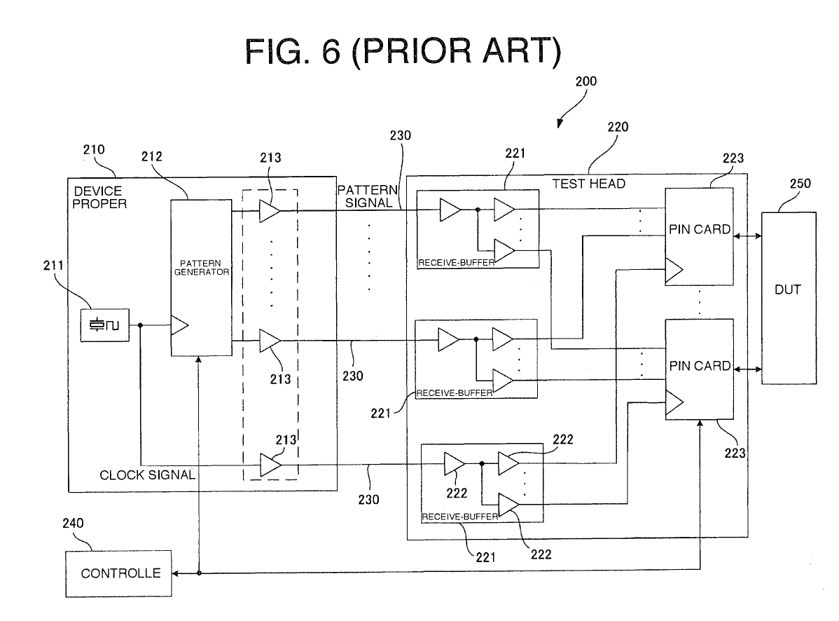

FIG. 7 is a schematic representation showing a state of transmission of pattern signals of the conventional semiconductor testing system.

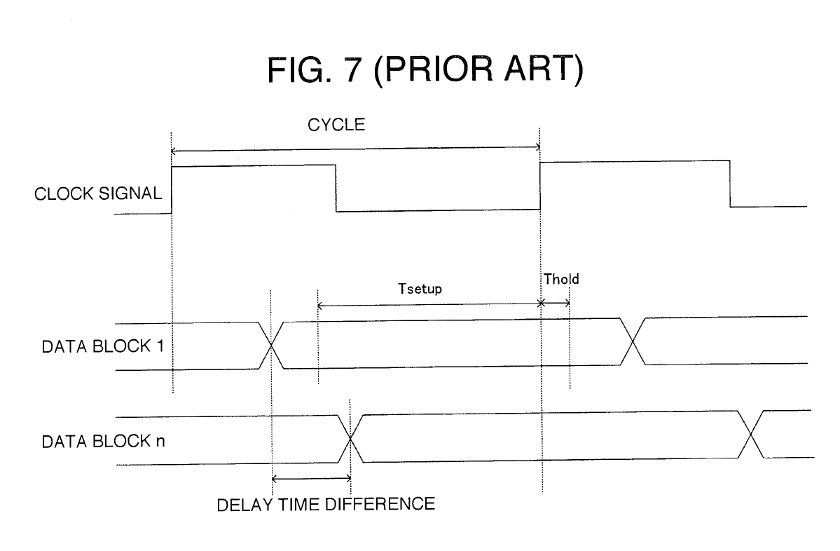

### PREFERRED EMBODIMENTS OF THE INVENTION

### First Embodiment

One embodiment of the invention is described hereinafter with reference to the accompanying drawings.

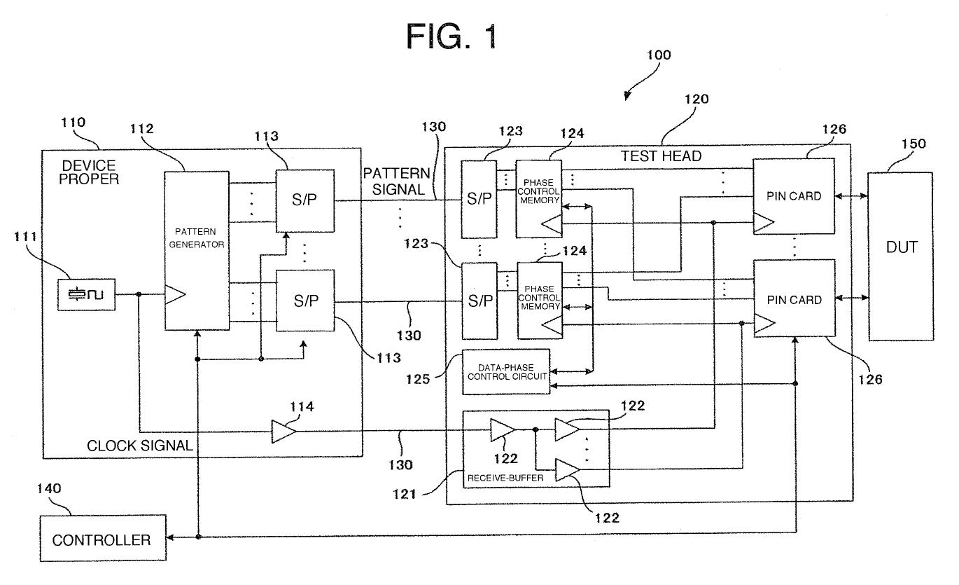

FIG. 1 is a schematic representation showing a configuration of a semiconductor testing system 100 according to one embodiment of the invention by way of example. The semiconductor testing system 100 is a system for conducting a test by generating pattern signals for use in testing a DUT 150 on the part of a system proper to be then transmitted via transmission paths using a transmission cable, respectively, and outputting the pattern signals to the DUT 150 on the part of a test head.

The semiconductor testing system 100 is made up of the system proper 110 including means for generating the pattern signals for use in testing the DUT 150, means for supplying power, and so forth, a test head 120 for placing the DUT 150 on a performance board, and outputting the pattern signals thereto to thereby conduct a test for checking a function as well as an operation of the DUT 150, and a controller 140 for controlling respective operations of the system proper 110, and the test head 120. The system proper 110 is connected to the test head 120 in such a way as to enable the pattern signals, and data to be transmitted via a plurality of transmission cables 130, respectively.

The system proper 110 is provided with a clock generator 111 for generating a clock signal to cause respective elements making up the semiconductor testing system 100 to be operated in sync therewith. The clock generator 111 is connected to a pattern generator 112, and a transmission buffer 114, having a function for generating the clock signal at a cycle of a predetermined time length to be outputted to the respective elements of the test head 120 through the intermediary of the pattern generator 112, and the transmission buffer 114, thereby causing the respective elements to be operated in sync with the clock signal.

Further, the system proper 110 is provided with the pattern generator 112 for generating the pattern signals for use in testing the DUT 150. The pattern generator 112 is connected to the clock generator 111, P/S converters 113, and the controller 140, and generates plural kinds of the pattern signals in parallel with each other, as a test signal for testing the DUT 150, the respective pattern signals having length in a range of several tens of bits to several hundreds of bits, to be subsequently outputted to the respective P/S converters 113.

The system proper 110 is provided with a plurality of the P/S converters 113 for executing serial conversion of the plural kinds of the pattern signals in parallel with each other, generated by the pattern generator 112, respectively. The respective P/S converters 113 are connected to the pattern generator 112, the respective transmission cables 130, and the controller 140, and execute the serial conversion of the plural kinds of the pattern signals outputted in parallel from the pattern generator 112 to be subsequently outputted toward the test head 120 via the respective transmission cables 130.

The system proper 110 is provided with the transmission buffer 114 for transmitting the clock signal generated by the clock generator 111 toward the test head 120 via the transmission cable 130.

The test head 120 is provided with a receive-buffer 121 for receiving the clock signal transmitted via the transmission cable 130 to be subsequently outputted to a plurality of pin cards 126 to be described later. The receive-buffer 121 is connected to the transmission cable 130 connected to the transmission buffer 114 and the plurality of the pin cards 126, and has a plurality of receive-circuits 122. The receive-circuits 122 is for causing the clock signal transmitted via the transmission cable 130 to branch off to be outputted to the respective phase control memories 124, and the respective pin cards 126, thereby operating the same in sync with the clock signal.

The test head 120 is further provided with S/P converters 123 for receiving the pattern signals transmitted via the transmission cable 130, thereby executing parallel conversion thereof, respectively. The respective S/P converters 123 are connected to the transmission cables 130 connected to the respective P/S converters 113, each having a function for determining the pattern signals transmitted via the respective transmission cables 130 by means of a CDR (Clock Data Recovery) circuit internally provided to carry out a process for executing the parallel conversion to thereby convert the pattern signals into the plural kinds of the pattern signals before outputting to the respective phase control memories 124.

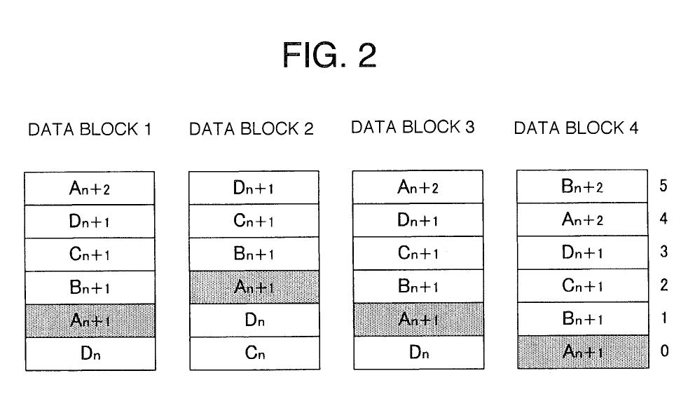

The test head 120 is further provided with a plurality of the phase control memories 124 for allocating the respective pattern signals subjected to the parallel conversion executed by the S/P converters 123 on the basis of each of a plurality of addresses before storing the same. FIG. 2 is a schematic representation showing a makeup of the plurality of the phase control memories 124 for allocating the plural kinds of the pattern signals on an address-by-address basis before storing the same. The respective phase control memories 124 storing, for example, data blocks from 1 to 4 are connected to the receive-buffer 121, the respective S/P converters 123, a data-phase control circuit 125, and the respective pin cards 126, allocating the data blocks from 1 to 4 to addresses 0 to 5, respectively, to thereby repeatedly store the plural kinds of the pattern signals of 8 bits, indicated by A, B, C, D, respectively, as shown in FIG. 2. Herein, n, n+1, n+2, . . . are numbers indicating the pattern signals that are concurrently generated by the pattern generator 112, respectively.

The test head 120 is provided with the data-phase control circuit 125 for executing processing for detecting a start address storing a first pattern signal at the start of reading at the time of testing from among a plurality of addresses of the phase control memory 124.

In this case, the start address is an address corresponding to a reading start position storing the pattern signal to be first read when the semiconductor testing system 100 executes a test for checking a function as well as an operation of the DUT 150, and sequentially reads the plural kinds of the pattern signals stored in the respective phase control memories 124 to be thereby outputted to the DUT 150.

The data-phase control circuit 125 is connected to the respective phase control memories 124, and the controller 140. The data-phase control circuit 125 executes processing for comparing the first pattern signal at the start of reading at the time of testing, as preset by user's actuation of operation means (not shown), with the respective pattern signals stored on an address-by-address basis in each of the phase control memories 124 by use of a comparator installed in the data-phase control circuit 125. On the basis of results of comparison, the data-phase control circuit 125 detects an address storing a pattern signal matching the first pattern signal, in respect of phase, thereby detecting the start address out of each of the phase control memories 124.

The data-phase control circuit 125 is made up by use of, for example, a CPU, a program or FPGA (Field Programmable Gate Array), and so forth, and is installed in a circuit apart from the phase control memories 124.

The test head 120 is provided with the plurality of the pin cards 126 for executing a test by sequentially reading the pattern signals stored at the respective addresses of the phase control memory 124 to be thereby outputted to the DUT 150, respectively. The respective pin cards 126 in a state as mounted in the test head 120 are connected to the receive-buffer 121, the phase control memories 124, the controller 140, and the DUT 150, so as to be operated in sync with the clock signal outputted from the receive-buffer 121, thereby sequentially reading the pattern signals stored at the respective addresses of the phase control memory 124 from the start address according to a test to be executed by the respective pin cards 126 before outputting the same to the DUT 150.

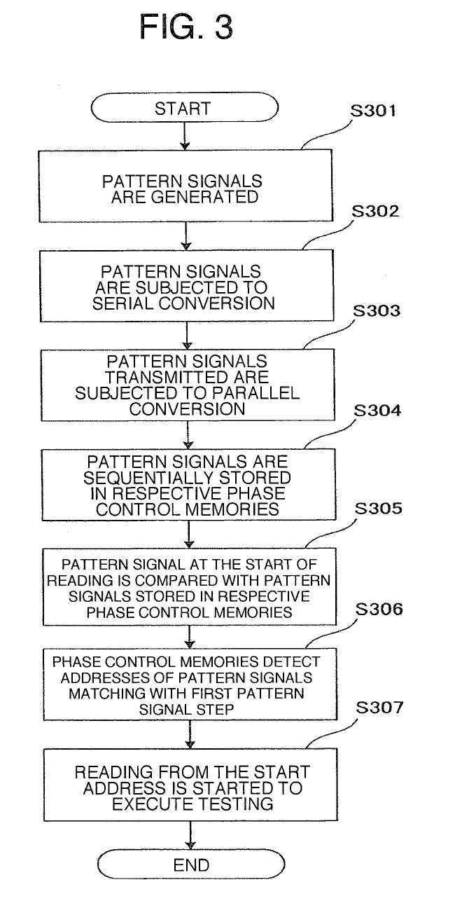

Subsequently, operation of the semiconductor testing system 100 according to the first embodiment of the invention is described hereinafter with reference to a flow chart shown in FIG. 3. First, the pin cards 126 are mounted on the test head 120, and the DUT 150 is placed on the performance board, and so forth, to be then connected to the respective pin cards 126, according to a test for checking the function as well as the operation of the DUT 150, whereupon the test is conducted with the respective elements within the semiconductor testing system 100 being kept under control by the controller 140. The following operation is executed at the time of an initial test when power supply of the semiconductor testing system 100 is turned on, or a calibration instruction is issued from the controller 140.

Step S301: The semiconductor testing system 100 executes processing whereby the pattern signal for testing the DUT 150 is generated by the pattern generator 112. The pattern generator 112 is operated in sync with the clock signal outputted from the clock generator 111 to generate the plural kinds of pattern signals in parallel with each other to be outputted to the P/S converters 113. For example, plural kinds of pattern signals indicated by A, B, C, C are generated in parallel with each other to be to be outputted to the P/S converters 113.
Step S302: The semiconductor testing system 100 executes processing whereby the respective P/S converters 113 execute serial conversion of the plural kinds of the pattern signals in parallel with each other, generated by the pattern generator 112. The respective P/S converters 113 receive the plural kinds of the pattern signals outputted from the pattern generator 112, and transmit the same after the serial conversion toward the test head 120 via the respective transmission cables 130.
Step S303: The semiconductor testing system 100 executes processing whereby the respective S/P converters 123 execute parallel conversion of the pattern signals transmitted via the respective transmission cables 130. The respective S/P converters 123 receive the pattern signals transmitted via the respective transmission cables 130, and output the same after the parallel conversion to the respective phase control memories 124.
Step S304: The semiconductor testing system 100 executes processing whereby the respective phase control memories 124 allocate the plural kinds of the pattern signals on an address-by-address basis to thereby store the same therein. The respective phase control memories 124 are operated in sync with the clock signal received from the clock generator 111 via the transmission buffer 114, and the receive-buffer 121, and the plural kinds of the pattern signals that have undergone the parallel conversion in step S303 are individually allocated one by one on an address-by-address basis to be sequentially stored in the respective phase control memories 124.

For example, the plural kinds of the pattern signals indicated by A, B, C, D, respectively, as shown in FIG. 2, are allocated one by one to the addresses 0 to 5, respectively, in the order of the pattern signal being outputted from each of the S/P converters 123 to be thereby sequentially and repeatedly stored in the respective phase control memories 124 as the data blocks from 1 to 4, respectively.

Step S305: The semiconductor testing system 100 executes processing whereby the data-phase control circuit 125 executes processing for comparing the first pattern signal at the start of reading at the time of testing with the pattern signals stored on the respective addresses of each of the phase control memories 124. The data-phase control circuit 125 executes processing for outputting the first pattern signal at the start of reading at the time of testing, as preset, to be thereby set and stored in the comparator installed in the data-phase control circuit 125. Then, storage operations of the respective phase control memories 124 are stopped at, for example, timing when the pattern signal is stored at all the addresses of the respective phase control memories 124, whereupon the comparator sequentially compares the first pattern signal at the start of the reading with the pattern signals stored on the respective addresses.

As shown in FIG. 2, the comparator installed in the data-phase control circuit 125 sequentially compares “A” pattern, which is the first pattern signal at the start of the reading, with the pattern signals stored at the addresses 0 to 5, respectively.

Step S306: The semiconductor testing system 100 executes processing whereby the data-phase control circuit 125 detects the start address out of each of the phase control memories 124. As a result of the first pattern signal at the start of the reading being sequentially compared with the pattern signals stored on the respective addresses, as in the step S305, the comparator installed in the data-phase control circuit 125 detects the first address storing the pattern signal matching the first pattern signal at the start of the reading, in respect of phase. The data-phase control circuit 125 receives respective data blocks at those addresses as detected, outputted from the comparator installed in the data-phase control circuit 125, thereby setting the same to the start address for each of the phase control memories 124.

For example, the comparator installed in the data-phase control circuit 125 sequentially compares the “A” pattern with the pattern signals stored at the addresses 0 to 5, respectively, as shown in FIG. 2, and as a result, the addresses 1, 2, 1, 0, as the first address storing the “A” pattern, respectively, are detected out of the data blocks 1, 2, 3, 4, respectively. Then, the data-phase control circuit 125 receives the respective data blocks at those addresses as detected, thereby setting the same to the respective start addresses.

Step S307: The semiconductor testing system 100 executes testing whereby the respective pin cards 126 start reading from the start address of the respective phase control memories 124, and sequentially reads the pattern signals to be thereby outputted to the DUT 150. The respective pin cards 126 are operated in sync with the clock signal received from the clock generator 111 via the transmission buffer 114, and the receive-buffer 121, referring to the start address for each of the phase control memories 124, as set by the data-phase control circuit 125. The respective pin cards 126 executes a test by starting to read from the pattern signal identical in phase to the start address of each of the phase control memories 124 and sequentially reading the respective addresses before outputting the same to the DUT 150.

For example, the respective pin cards 126 start reading from the “A” pattern identical in phase to the addresses 1, 2, 1, 0, set by the data-phase control circuit 125, as the first address storing the “A” pattern, respectively, as shown in FIG. 2. The respective pin cards 126 executes the test by sequentially reading from the respective addresses of the data blocks 1, 2, 3, 4 before outputting the same to the DUT 150.

As described above, the semiconductor testing system 100 according to the first embodiment of the invention executes processing whereby the pattern signals generated by the pattern generator 112 are subjected to the serial conversion to be transmitted toward the test head 120, and the pattern signals transmitted via the respective transmission cables 130 are subjected to the parallel conversion. Further, processing is executed whereby the plural kinds of the pattern signals after the parallel conversion are allocated one by one on an address-by-address basis to be stored in the respective phase control memories 124 to thereby detect the start address storing the pattern signal matching the first pattern signal at the start of the reading, in respect of phase. Then, the test is executed by starting to read from the start address, and sequentially reading the respective pattern signals to be subsequently outputted to the DUT 150.

Accordingly, since the plural kinds of the pattern signals generated in parallel with each other are subjected to the serial conversion to be then transmitted via the respective transmission cables 130, higher speed of transmission can be attained while holding back an increase in the number of the transmission cables 130.

When the pattern signals are transmitted via the transmission cables 130, respectively, even if there occurs a difference in delay time between the cables due to difference in type between the transmission cables 130, an error in wiring length, and so forth, it is possible to implement alignment in phase between the respective phase control memories 124, and to sequentially read from the identical pattern signal, thereby preventing delay from occurring between the respective transmission cables 130 because the pattern signals are stored in the respective phase control memories 124 to thereby detect the start address, and reading is stared from the start address. Furthermore, since the delay between the respective transmission cables 130 is prevented through the alignment in phase, excessive requirements for wiring length of each of the transmission cables 130 is eliminated, so that reduction in manufacturing cost can be achieved.

### Second Embodiment

A second embodiment of the invention is described hereinafter with reference to the accompanying drawings.

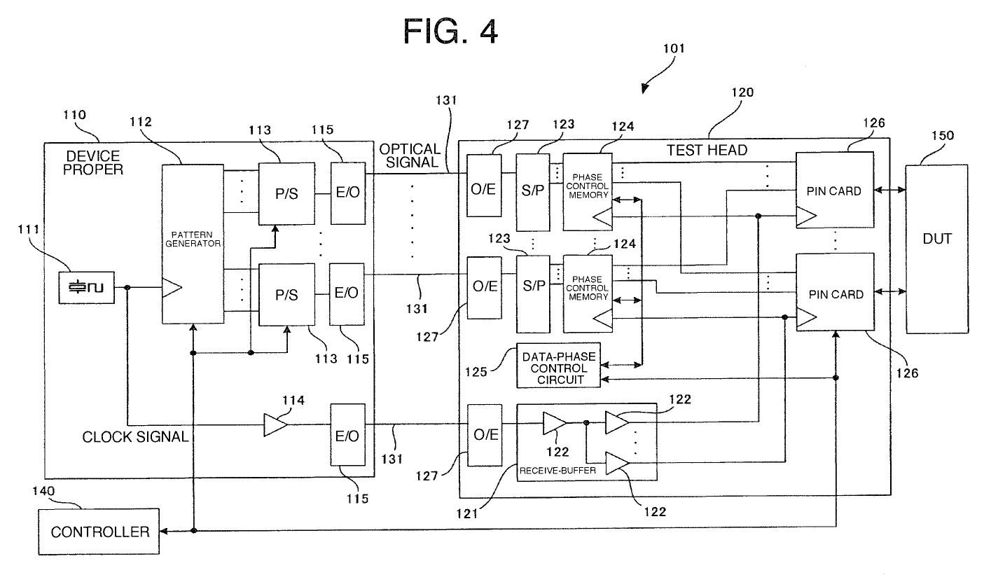

FIG. 4 is a schematic representation showing a configuration of a semiconductor testing system 101 according a second embodiment of the invention by way of example. With the semiconductor testing system 101, a system proper 110 thereof is provided with a plurality of E/O converters 115 whereby pattern signals subjected to serial conversion by respective P/S converters 113, and a clock signal are converted from respective electrical signals to an optical signal, each of the E/O converters 115 being disposed between a transmission buffer 114, and a transmission cable 131 as well as between each of the P/S converter 113, and the transmission cable 131. A test head 120 is provided with S/P converters 123, and a plurality of O/E converters 127 for converting the pattern signal, and the clock signal, transmitted via the respective transmission cables 131, from the optical signal to electrical signals, each of the O/E converters 127 being disposed between a receive-buffer 121, and the transmission cable 131 as well as between each of S/P converters 123, and the transmission cable 131.

Further, the semiconductor testing system 101 is provided with the transmission cables 131 for interconnecting the E/O converters 115 and the O/E converters 127, respectively, by use of an optical fiber. The semiconductor testing system 101 is the same in configuration in other respects as the semiconductor testing system 100 according to the first embodiment of the invention, omitting therefore description thereof.

With the semiconductor testing system 101 according to the second embodiment, the pattern signal subjected to the serial conversion by each of the P/S converters 113 is converted from the electrical signal to the optical signal by each of the E/O converters 115 to be subsequently transmitted toward the test head 120 via each of the transmission cables 131. Then, the pattern signal transmitted via each of the transmission cables 131 is converted from the optical signal to the electrical signal by each of the O/E converters 127, whereupon the respective S/P converters 123 execute parallel conversion of the pattern signal to be subsequently outputted to respective phase control memories 124.

Further, the E/O converter 115 receives a clock signal generated by a clock generator 111, and converts the clock signal from an electrical signal to an optical signal to be thereby transmitted toward the test head 120 via the transmission cable 131. The O/E converter 127 converts the clock signal transmitted via the transmission cable 131 from the optical signal to the electrical signal to be thereby outputted to the respective phase control memories 124, and respective pin cards 126.

For that purpose, the optical signals are transmitted via the respective transmission cables 131, so that it is possible to implement transmission at a high speed without increasing the number of the transmission cables, and to extend a wiring length. Use of the optical fibers enables the respective transmission cables 131 to be light in weight, and small in diameter, so that the respective transmission cables 131 can be handled with greater ease, thereby preventing the same from interfering with movability of the test head 120.

### Third Embodiment

A third embodiment of the invention is described hereinafter with reference to the accompanying drawing.

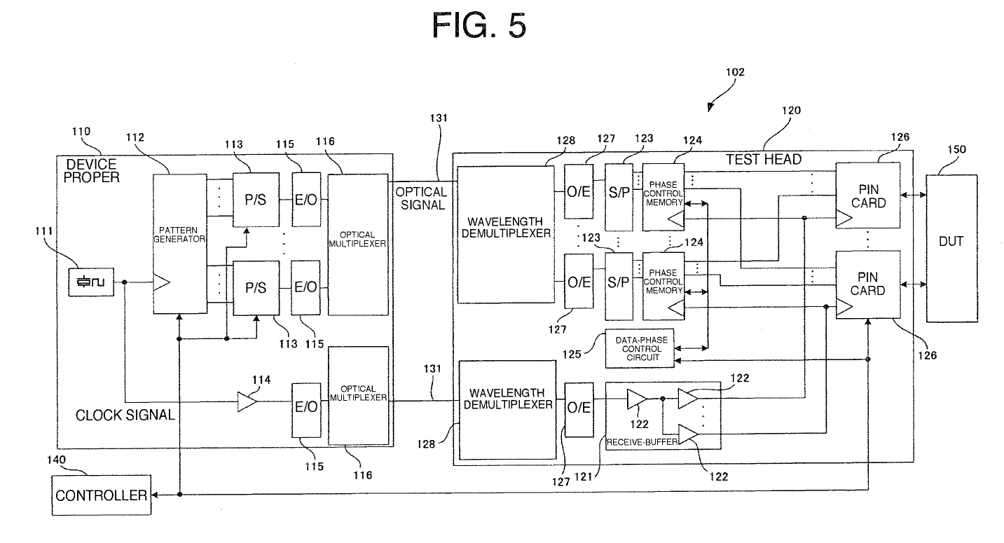

FIG. 5 is a schematic representation showing a configuration of a semiconductor testing system 102 according to a third embodiment of the invention by way of example. With the semiconductor testing system 102, WDM (Wavelength Division Multiplexing) is adopted when transmitting an optical signal. In a system proper 110, an optical multiplexer 116 for generating an optical composite signal synthesized of a plurality of optical signals converted by respective E/O converters 115 is provided between the respective E/O converters 115, and a transmission cable 131. In a test head 120, a wavelength demultiplexer 128 for distributing the optical composite signal transmitted via the transmission cable 131 into a plurality of optical signals is provided between respective O/E converters 127, and the transmission cable 131. The semiconductor testing system 102 is the same in configuration in other respects as the semiconductor testing system 101 according to the second embodiment of the invention, omitting therefore description thereof.

With the semiconductor testing system 102 according to the third embodiment, the optical multiplexer 116 synthesizes the plurality of the optical signals converted from electrical signals, respectively, by the respective E/O converters 115, to thereby generate the optical composite signal, which is then transmitted toward the test head 120 via the transmission cable 131. Then, the optical composite signal transmitted via the transmission cable 131 is distributed into a plurality of optical signals by the wavelength demultiplexer 128 to be subsequently converted into electrical signals, by the O/E converters 127.

Accordingly, with the third embodiment, the same advantageous effect as that for the second embodiment can be obtained, and since the optical composite signal synthesized of the plurality of the optical signals is transmitted via the transmission cable 131, it becomes possible to transmit plural kinds of optical signals with the use of one length of the transmission cable 131, so that transmission at a high speed can be implemented while significantly reducing the number of the transmission cables 131.

### Other Embodiments

With those embodiments described hereinbefore, the data-phase control circuit 125 may change, and set the first pattern signal at the start of the reading at the time of testing by the user's actuation of the operation means (not shown). With the adoption of such a configuration as described, it is possible to cope with the case where the content of the test, and test conditions are changed, and the case where delay time in transmission undergoes a change due to a change in type of the transmission cable 130, and so forth by changing an algorithm for detecting the first pattern signal at the start of the reading, and the start address.

Further, the phase control memory 124 may change its capacity such as the number of the addresses, and so forth.

What is claimed is:

1. A semiconductor testing system comprising:
a pattern generator for generating pattern signals for use in testing a device under test;
serial converters for executing serial conversion of the pattern signals generated by the pattern generator, respectively;
transmission paths for transmitting the pattern signals subjected to the serial conversion by the serial converters, respectively;
a plurality of memories for subjecting the pattern signals transmitted via the respective transmission paths to parallel conversion to be stored therein; and
a pattern output unit for starting to read the respective pattern signals from a reading start position of the pattern signal at the time of testing against each of the plurality of the memories to thereby output the respective pattern signals to the device under test.

2. A semiconductor testing system comprising:
a pattern generator for generating pattern signals for use in testing a device under test;
serial converters for executing serial conversion of the pattern signals generated by the pattern generator, respectively;
transmission paths for transmitting the pattern signals subjected to the serial conversion by the serial converters, respectively;
parallel converters for executing parallel conversion of the pattern signals transmitted via the respective transmission paths;
a plurality of memories for allocating the respective pattern signals subjected to the parallel conversion executed by the parallel converters on the basis of every address to be subsequently stored therein;
a start address detection unit for detecting a start address corresponding to a reading start position of the pattern signal at the time of testing from among a plurality of addresses of the memory out of each of the memories; and
a pattern output unit for starting to read the respective pattern signals from the start address of each of the plurality of the memories, detected by the start address detection unit, against each of the plurality of the memories, to thereby output the respective pattern signals to the device under test.

3. The semiconductor testing system according to claim 2, wherein the start address detection unit comprises:
a pattern comparator for comparing a first pattern signal at the start of reading at the time of testing, as preset, with the respective pattern signals stored on an address-by-address basis in each of the plurality of the memories; and
pattern comparison detector for detecting an address storing a pattern signal matching the first pattern signal, in respect of phase, on the basis of results of comparison made by the pattern comparator, out of each of the plurality of the memories.

4. The semiconductor testing system according to claim 3, the pattern comparator further comprises a pattern setter for optionally setting the first pattern signal to be compared with the respective pattern signals stored on an address-by-address basis in each of the plurality of the memories.

5. A semiconductor testing system comprising:
a pattern generator for generating pattern signals for use in testing a device under test;
first optical converters for converting the pattern signals generated by the pattern generator, respectively, from electrical signals to optical signals;
optical transmission paths for transmitting the optical signals converted by first optical converters, respectively;
second optical converters for converting the optical signals transmitted via the optical transmission paths into pattern signals as voltage signals, respectively;
a plurality of memories for allocating the respective pattern signals converted by the second optical converters on an address-by address basis to be subsequently stored therein;
a start address detection unit for detecting a start address corresponding to a reading start position of the pattern signal at the time of testing from among a plurality of addresses of the memory out of each of the memories; and
a pattern output unit for starting to read the respective pattern signals from the start address of each of the plurality of the memories, detected by the start address detection unit, against each of the plurality of the memories, to thereby output the respective pattern signals to the device under test.

6. The semiconductor testing system according to claim 5, further comprising:
an optical multiplexer for transmitting an optical composite signal synthesized of a plurality of optical signals converted by each of the first optical converters via the optical transmission path; and
a wavelength demultiplexer for distributing the optical composite signal transmitted via the optical transmission path into a plurality of optical signals.
